(19) United States
(12) Patent Application Publication
(10) Pub. No.: US 2001/0056545 A1
(43) Pub. Date: Dec. 27, 2001

(54) GUI-equipped terminal apparatus, resource control terminal apparatus, network system, medium, and information aggregate

(75) Inventors: Hideaki Takechi, Osaka (JP); Tomoaki Watahiki, Osaka (JP); Naonori Kato, Osaka (JP); Kouichi Matsumura, Osaka (JP); Masao Ikezaki, Osaka (JP)

Correspondence Address: Allan Ratner, Ratner & Prestia, One Westlakes, Berwyn, Suite 301, P.O. Box 980, Valley Forge, PA, 19482-0980, US

(73) Assignee: Matsushita Electric Industrial Co., Ltd.

(21) Appl. No.: 09/867,906

(22) Filed: May 30, 2001

(30) Foreign Application Priority Data
May 30, 2000 (JP) 2000-159,316

(51) Int. Cl. G06F 11/30

(52) U.S. Cl. 713/200; 713/190

(57) ABSTRACT

A GUI-equipped terminal apparatus which is connected to another terminal device through a network, and forms a distributed software environment, has

GUI display means;

a virtual language environment which is a program execution environment in which a program code generated in a predetermined language can be executed independent of a specific type of apparatus;

access limit confirmation means of operating in another execution environment different from the virtual language environment; and

network I/F means, wherein:

the network I/F means exchanges information with another terminal device through the network;

the GUI display means displays an application GUI at an instruction from an application executed in the virtual language environment, and displays an access limit confirmation GUI at an instruction from the access limit confirmation means; and

the access limit confirmation means receives an access confirmation message encrypted by another terminal device through the network I/F means, and transmits an encrypted access confirmation reply message to the other terminal device through the network I/F means.

### BACKGROUND OF THE INVENTION

1. Field of the Invention

The present invention relates to a GUI-equipped terminal apparatus, a resource control terminal apparatus, a network system, a medium, and an information aggregate capable of limiting access in a virtual language environment which is a program execution environment for executing a program code generated in a predetermined program language independent of a model of a computer.

2. Description of the Prior Art

Recently, with remarkable progress of computer network technology and corresponding development of distributed virtual languages such as Java language, CORBA language, etc., a distributed network environment in which a program written in a virtual language of a terminal can easily invoke a program written in a virtual language of another terminal has been realized.

By using a virtual language, it is not necessary to develop a program for each machine because the same program can be executed in the virtual language environment of any machine. Additionally, since everybody can write a program based on a published virtual language specification, there can be a variety of programs, thereby realizing an excellent distributed virtual language environment.

On the other hand, digital electric appliances for home use such as digital television sets, digital video recorders, etc. have been put to more practical use. The recent research and development aims at interconnecting these appliances through a home network, and introducing a distributed virtual language environment so that the distributed network of the electric appliances for home use can be furthermore improved. In the above mentioned distributed home network of electric appliances for home use, in addition to the utilization of the above mentioned program, sharing the resources and the utilization of each appliance by, for example, accessing Internet using a modem built in a television set through a video recorder having no modem to obtain information, etc. are expected to proceed powerfully.

A problem of such a network is to determine how to acquire permission to access the shared resources. For example, when a user is permitted to access only after confirming the intention of the user because of toll resources, or when parental control is realized not to permit young people to access undesired pictures, etc., it is necessary to establish the technology of permitting access by correctly reflecting the intention of a user depending on the applications and resources.

An example of conventional means of permitting access by confirming the intention of a user can be a dialog window used in a personal computer. This is a method of, for example, displaying a dialog window, notifying a user that a connection is being established, and confirming the intention of the user to establish the connection when an application is accessing specific resources, that is, when WorldWideWeb browser is establishing a connection to Internet through a modem, etc.

In the distributed network environment, with the configuration shown in FIG. 8, a dialog window as the one used in the personal computer can be used. The operations will be described below by referring to FIG. 8. The present network system is configured by connecting a TV 801 to a modem 802 through a network 815. The TV 801 and the modem 802 can transmit and receive a message to and from each other through network I/F 810 and 811.

The TV 801 is provided with a display 812, GUI display means 805, and a network I/F 810. Furthermore, the TV 801 is provided with a JavaVirtualMachine (hereinafter referred to as JavaVM) 803 as a virtual language environment, and can execute a Web browser application 808 interpreted and executed by the JavaVM 803.

A modem 802 includes a modem circuit 813 and the network I/F 811. Additionally, the modem 802 is provided with a JavaVM 804 as a virtual language environment, and can execute a modem control program 809 interpreted and executed by the JavaVM 804.

The modem circuit 813 is connected to a public network 814, and connects the line with a telephone number specified, thereby accessing Internet.

The modem control program 809 receives a request from another Java program in the network through the JavaVM 804, and processes and determines the request to operate the modem circuit 813, thereby successfully allowing the other Java program in the network to share the functions of the modem circuit 813.

Furthermore, the modem circuit 813 does not publish an API through the Java VM directly to other Java programs in the network, and is directly controlled only from the modem control program 809.

Relating to the conventional example configured as described above, the procedure of accessing Internet by the Web browser application 808 using the modem circuit 813 through the public network 814 is described below.

In the conventional example, it is assumed that the Web browser application 808 issues an access request to the modem control program 809 through a network. When the access request practically request a connection of a public line, a user is charged. Therefore, it is necessary to confirm the intention of the user.

In this case, the modem control program 809 requests the Web browser application 808 to confirm the acceptance of the charge to the user through the network by transmitting an access confirmation message to the Web browser application 808. The Web browser application 808 performs a GUI drawing process on the display 812 through the image drawing library of the JavaVM 803 and the GUI display means 805, confirms the intention of the user, and notifies the modem control program 809 of the result using the access confirmation reply message. As a result, the modem control program 809 connects the modem circuit 813 to the public network 814 when the user indicates the affirmative intention.

### BRIEF SUMMARY OF THE INVENTION

Object of the Invention

However, the user intention confirmation means used in the above mentioned distributed network environment has several problems as follows.

First, an illegal program using a false access confirmation reply message can be easily prepared regardless of the intention of a user because the language specification of a virtual language is widely disclosed, and any user can generate an application. Therefore, an automatic program for operating itself by freely using resources regardless of the intention of a user, that is, a virus program, can be easily prepared.

Furthermore, although an access confirmation message, a reply message, etc. are encrypted, an application program can be easily analyzed as a feature of a virtual language. Therefore, it is hard to keep the security of the encryption to guarantee the confirmation of the user intention.

That is, there is a problem (first problem) that it is normally difficult to confirm the intention of a user by safely displaying the dialog on a remote GUI-equipped terminal apparatus without fail.

Furthermore, in the above mentioned conventional technology, it is necessary to fix the message specification, etc. between resources and an application. To widely disclose the specification cannot attain the purpose of safely displaying messages. On the other hand, to limit the disclosure also limits the number of users who can generate an application. Thus, there is the problem that it is very difficult to allow a large number of users to safely generate applications.

That is, there is the problem (second problem) that allowing a large number of user to generate an application with the specification of a message published is inconsistent with displaying a dialog with safe to obtain user's confirmation.

On the other hand, there is another problem that a terminal displaying a dialog is not always an appropriate terminal on which an access permission can be obtained. For example, a user who uses the terminal displaying the dialog has the right to permit access to the resources. If there is a user for whom a dialog is displayed, and another user having the right to permit access, then a procedure is required between these users until access is permitted, which is an inconvenient process.

Furthermore, to remove the inconvenience relating to the right to permit access, a method of broadcasting a user intention confirmation request to a plurality of terminals to take action depending on the reply results from the terminals is used. In this method, when a plurality of users have a right to permit access, there can be a plurality of answers inconsistent with one another, thereby causing the problem of the conflict among the answers.

That is, if a user intention confirmation request is broadcast to a plurality of GUI-equipped terminal apparatuses, and the answers from the GUI-equipped terminal apparatuses are accepted, then there can be the conflict among the plurality of answers (third problem).

On the other hand, there is the problem that there occurs a by-product by an interrupting display of a dialog in the terminal of displaying a dialog. For example, if pictures are recorded while watching the TV, if an access confirmation request message is received from an unrelated unit, and if the message is multiplexed on the TV image as an OSD (On Screen Display), then the message can be multiplexed to a picture to be recorded, thereby possibly failing in successfully recording a target image.

That is, there is the problem (fourth problem) that, in the GUI-equipped terminal apparatus, an image may not be successfully recorded by multiplexing an interrupting display of a dialog to a picture to be recorded.

Furthermore, on the other hand, in a system requiring the confirmation of a user when specific resources are used, and when a reserving operation is performed to record a program at a predetermined time, the user is informed that the reserved recording process has been successfully performed on a reserved time, but it proves that the user has no right to access the resources at a predetermined time, and that the user is absent at the predetermined time. In this case, the reserved process may not be performed.

That is, there is the problem (fifth problem) that a reserving operation at a predetermined time for a reservation recording process may not be performed.

The 1st invention of the present invention is a GUI-equipped terminal apparatus which is connected to another terminal device through a network, and forms a distributed software environment, comprising:

GUI display means;

a virtual language environment which is a program execution environment in which a program code generated in a predetermined language can be executed independent of a specific type of apparatus;

access limit confirmation means of operating in another execution environment different from said virtual language environment; and

network I/F means, wherein:

said network I/F means exchanges information with another terminal device through the network;

said GUI display means displays an application GUI at an instruction from an application executed in said virtual language environment, and displays an access limit confirmation GUI at an instruction from said access limit confirmation means; and

said access limit confirmation means receives an access confirmation message encrypted by another terminal device through said network I/F means, and transmits an encrypted access confirmation reply message to said other terminal device through said network I/F means.

The 2nd invention of the present invention is the GUI-equipped terminal apparatus according to 1st invention further comprising display means of displaying an image drawing signal output from said GUI display means on a monitor, wherein:

said GUI display means has an external output terminal;

said GUI display means displays the application GUI at an instruction from an application executed in said virtual language environment only on said display means or both said display means and said external output terminal; and

when an instruction from said access limit confirmation means is received, said access limit confirmation GUI is displayed only on said display means, and not on said external output terminal.

The 3rd invention of the present invention is a resource control terminal apparatus which is connected to another terminal device through a network, and forms a distributed software environment, comprising:

a virtual language environment which is a program execution environment in which a program code generated in a predetermined language can be executed independent of a specific type of apparatus;

access limit search means of operating in another execution environment different from said virtual language environment; and

network I/F means, wherein:

said network I/F means exchanges information with said another terminal device through said network;

said access limit search means receives and encrypts an access limit search request from an resource control program code executed in said virtual language environment, and transmits the access confirmation message to said other terminal device through said network I/F means, receives and decrypts an encrypted access confirmation reply message from said other terminal device through said network I/F means; and

said access limit search means answers said access limit search request from there source control program code according to said decrypted access confirmation reply message.

The 4th invention of the present invention is the resource control terminal apparatus according to 3rd invention, wherein:

said access limit search means receives an access limit search request specifying an optional program ID from said resource control program code;

said access limit search means retrieves said other terminal device in which a program having said program ID is being executed;

said access limit search means transmits said encrypted access confirmation message to said retrieved other terminal device through said network I/F means;

said access limit search means receives an encrypted access confirmation reply message from said retrieved other terminal device through said network I/F means, decrypts said encrypted access confirmation reply message and decrypted; and said access limit search means answers an access limit search request from said resource control program code according to said decrypted access confirmation reply message.

The 5th invention of the present invention is the resource control terminal apparatus according to 3rd invention, wherein:

said access limit search means receives an access limit search request specifying a profile ID from said resource control program code;

said access limit search means retrieves a terminal device having a permission right corresponding to said profile ID;

said access limit search means transmits an encrypted access confirmation message to a terminal device having said permission right through said network I/F means;

said access limit search means receives an encrypted access confirmation reply message from the terminal device having said permission right through said network I/F means, and decrypts said encrypted access confirmation reply message; and

said access limit search means answers an access limit search request from said resource control program code according to said decrypted access confirmation reply message.

The 6th invention of the present invention is a network system, comprising:

at least one GUI-equipped terminal apparatus connected to a network; and

at least one resource control terminal apparatus connected to said network, wherein:

said GUI-equipped terminal apparatus and said resource control terminal apparatus form a distributed software environment;

said GUI-equipped terminal apparatus comprises:

GUI display means;

a first virtual language environment which is a program execution environment in which a program code generated in a predetermined language can be executed independent of a specific type of apparatus;

access limit confirmation means of operating in another execution environment different from said first virtual language environment; and

first network I/F means, wherein:

said resource control terminal apparatus comprises:

a second virtual language environment which is a program execution environment in which a program code generated in said predetermined language can be executed independent of a specific type of apparatus;

access limit search means of operating in another execution environment different from said second virtual language environment; and

second network I/F means, wherein:

said first network I/F means exchanges information with said resource control terminal apparatus through said network;

said second network I/F means exchanges information at least with said GUI-equipped terminal apparatus through said network;

said access limit search means receives an access limit search request from a resource control program code executed in said second virtual language environment, and encrypts the request, and transmits said access confirmation message to said GUI-equipped terminal apparatus through said second network I/F means;

said access limit confirmation means receives said encrypted access confirmation message from said access limit search means through said first network I/F means, decrypts said access confirmation message, and outputs the decrypted message to said GUI display means;

said GUI display means displays an application GUI at an instruction from an application executed in said first virtual language environment, and displays an access limit confirmation GUI upon receipt of said access confirmation message from said access limit confirmation means;

said GUI display means outputs an input to said access limit confirmation GUI to said access limit confirmation means;

said access limit confirmation means generates an access confirmation reply message from said input and encrypts the message, said encrypted access confirmation reply message is transmitted to said resource control terminal apparatus through said first network I/F means; and

said access limit search means receives the encrypted access confirmation reply message from said GUI-equipped terminal apparatus through said second network I/F means, decrypts the message, and answers the access limit search request from said resource control program code according to said decrypted access confirmation reply message.

The 7th invention of the present invention is the network system according to 6th invention, wherein: plurality of

said GUI-equipped terminal apparatus is connected to a plurality of said networks;

said resource control terminal apparatus broadcasts an access confirmation message to said GUI-equipped terminal apparatus;

when said GUI-equipped terminal apparatus is directly operated by a user, does not receive another access confirmation reply message in response to said access confirmation message from said other GUI-equipped terminal apparatus, and receives said access confirmation message transmitted from said resource control terminal apparatus, said GUI-equipped terminal apparatus transmits an access limit confirmation receipt message, performs a GUI display, confirms a request of the user, and broadcasts an access confirmation reply message.

The 8th invention of the present invention is the network system according to 6th or 7th inventions, wherein:

said access confirmation message transmitted from said resource control terminal apparatus contains bit map data of a GUI image for a user selecting information about access limit requested from said application;

said access confirmation reply message transmitted from said GUI-equipped terminal apparatus contains coordinates of a position at which the user performs an action on said bit map data of said GUI image;

said resource control terminal apparatus confirms selection of a user for information about said access limit based on said coordinates of the position, and answers the access limit search request from said application based on said selection of the user.

The 9th invention of the present invention is the network system according to 8th invention, wherein said resource control terminal apparatus changes a position or an expression of a GUI unit forming bit map data of a GUI image contained in said access confirmation message each time said resource control terminal apparatus transmits said access confirmation message.

The 10th invention of the present invention is the resource control terminal apparatus according to 3rd invention, wherein said resource control program code comprises the steps of:

transmitting said access limit search request when an access request is received from another program;

receiving a reply to said access limit search request; and

determining according to said reply whether or not said access request can be accessed.

The 11th invention of the present invention is the resource control terminal apparatus according to 4th invention, wherein said resource control program code comprises the steps of:

specifying a program ID indicating the other program to said access limit search means when an access request is received from the other program;

transmitting said access limit search request; receiving a reply to said access limit search request; and

determining whether or not access at said access request can be accepted according to said reply.

The 12th invention of the present invention is the resource control terminal apparatus according to 5th invention, wherein said resource control program code comprises the steps of:

specifying said profile for said access limit search means when receiving an access request from another program;

transmitting said access limit search request;

receiving a reply to said access limit search request; and

determining whether or not said access request can be accepted according to said reply.

The 13th invention of the present invention is the resource control terminal apparatus according to any one of 3rd to 5th inventions, wherein said resource control program code comprises the steps of:

performing an access limit search request in a same procedure as an access confirmation request issued from a current program when receiving an access confirmation request from another program; and

determining whether or not the access confirmation request can be accepted according to a reply to the request.

The 14th invention of the present invention is a computer-processible medium storing a program and/or data used to direct a computer to perform all or a part of functions of all or a part of means of the resource control terminal apparatus or the GUI-equipped terminal apparatus according to any one of 1st to 9th inventions.

The 15th invention of the present invention is an information aggregate which is a program and/or data used to direct a computer to perform all or a part of functions of all or apart of means of the resource control terminal apparatus or the GUI-equipped terminal apparatus according to any one of 1st to 9th inventions.

The 16th invention of the present invention is a computer-processible medium storing the steps of all or a part of said resource control program code of said resource control terminal apparatus according to any one of 10th to 13th inventions.

The present invention has been developed to solve the above mentioned first problem, and aims at providing a GUI-equipped terminal apparatus, a resource control terminal apparatus, a network system, a medium, and an information aggregate capable of safely showing a dialog on a remote GUI-equipped terminal apparatus, and issuing an instruction from a user to limit access to any resources in a network.

The present invention has also been developed to solve the above mentioned second problem, and aims at providing a GUI-equipped terminal apparatus, a resource control terminal apparatus, a network system, a medium, and an information aggregate capable of generating an application in a virtual language based on a published specification.

The present invention has also been developed to solve the above mentioned third problem, and aims at providing a GUI-equipped terminal apparatus, a resource control terminal apparatus, a network system, a medium, and an information aggregate capable of avoiding the conflict among answers when a dialog is displayed to a user having a right to permit access, and a plurality of users have the right to permit access.

The present invention has also been developed to solve the above mentioned fourth problem, and aims at providing a GUI-equipped terminal apparatus, a resource control terminal apparatus, a network system, a medium, and an information aggregate capable of avoiding a by-product by an interrupting display of a dialog.

The present invention has also been developed to solve the above mentioned fifth problem, and aims at providing a GUI-equipped terminal apparatus, a resource control terminal apparatus, a network system and a medium, capable of performing a reserving operation without fail at a predetermined time although a user is absent.

For example, the present invention has the following means to solve the above mentioned problems

First, a terminal with the configuration described in claim 1 is used as a GUI terminal. That is, a GUI-equipped terminal apparatus is connected to another terminal device through a network to establish a distributed software environment, and includes GUI display means, a virtual language environment, access limit confirmation means, and network I/F means. The GUI display means performs a GUI displaying process at instructions from an application performed in the virtual language environment and from the access limit confirmation means. The access limit confirmation means receives an encrypted access confirmation message from another terminal device through the network I/F means, and transmits an encrypted access confirmation reply message to another terminal device through the network I/F means.

Second, a terminal with the configuration described in claim 3 is used to control resources. That is, a resource control terminal apparatus is connected to another terminal device through a network to establish a distributed software environment, and includes a virtual language environment, access limit search means, and network I/F means. The access limit search means receive an access limit search request from a program code executed in the virtual language environment, transmits an encrypted access confirmation message to another terminal device through the network I/F means, receives and decrypts an encrypted access confirmation reply message from another terminal device through the network I/F means, and answers the access limit search request from the program code executed in the virtual language environment according to the decrypted access confirmation reply message.

Third, as described in claim 6, a network system can be configured by connecting at least one GUI-equipped terminal apparatus to at least one resource control terminal apparatus.

Fourth, the program code described in claim 11 is executed in the virtual language. This program code is executed in the virtual language environment of the resource control terminal apparatus in the network system. Upon receipt of an access request from another program, the program code first transmits an access limit search request, then receives a response to the access limit search request, and determines whether or not the access request can be accepted depending on the response.

Using the system with the above mentioned configuration and the program code operating in the system, dialog can be automatically displayed on a remote GUI-equipped terminal apparatus, and a user can specify access limit on any resource in the network only by issuing an access request from the application to the program code when an optional application described in a virtual language is operating in the virtual language environment of a terminal device. With the configuration, the intention of a user can be confirmed independent of the virtual language, and the message can be encrypted by the access limit confirmation means and the access limit search means independent of the virtual language, thereby safely and correctly issuing an instruction. At this time, the application can be generated in the virtual language based on the published specification.

Furthermore, to guarantee the security for the displayed dialog and a response, the system described in claim 8 is adopted. This system is a network system described in claim 6 or 7. The access confirmation message transmitted from the resource control terminal apparatus includes bit map data of a GUI image for allowing a user to select the information relating to limiting access requested by an application, the access confirmation reply message transmitted from the GUI-equipped terminal apparatus includes the coordinates of the position at which the user performs an action on the bit map data of the GUI image, the resource control terminal apparatus confirms the user selection about the information relating to limiting access according to the coordinates of the position at which the user performs the action on the bit map data, and a reply to the access limit search request from the application can be issued based on the user selection.

In this system, although a malicious third party tries to forge an access confirmation reply message, the coordinates of the position at which a desired answer is displayed cannot be generated without recognizing the bit map. Therefore, it is difficult to generate a virus program.

To further enhance the security, the system described in claim 9 is used. This system is a network system according to claim 8, and changes the position or representation of a GUI unit forming the bit map data of a GUI image contained in the access confirmation message each time the resource control terminal apparatus transmits an access confirmation message. In this system, although a malicious third party tries to estimate the coordinates of the position at which a desired answer is displayed by tapping a wire for an access confirmation message and a reply message, the bit mat is changed each time, and the texture, etc. forming the position and the bit map is changed. Therefore, it is exceedingly difficult to analyze these data, thereby further hardening the generation of a virus program.

Furthermore, a terminal having the configuration according to claim 2 is used as a GUI-equipped terminal apparatus to avoid the by-product of interrupting display of dialog. That is, the GUI-equipped terminal apparatus is connected to another terminal device through a network to establish a distributed software environment, and includes GUI display means, a virtual language environment, access limit confirmation means, network I/F means, and display means. The GUI display means has one or more outputs. The one or more outputs are connected to the external output terminals to the display means or terminal. The GUI display means has the function of performing the GUI displaying process on the display means only or on both display means and external output terminal at an instruction from the application executed in the virtual language environment. Furthermore, the GUI display means has the function of performing 784 the GUI displaying process only on the display means at an instruction from the access limit confirmation means. The access limit confirmation means receives an encrypted access confirmation message from another terminal device through the network I/F means, and transmits an encrypted access confirmation reply message to another terminal device through the network I/F means.

Using the GUI display terminal according to the present invention, a user can display data on the display means for visual confirmation through a specific GUI using an access confirmation message from another terminal, and can avoid a by-product of an interrupting display of dialog without OSD to an external output terminal, etc. for recording.

Furthermore, to solve the problem that a destination terminal to display the dialog on is not always an appropriate terminal for obtaining permission for access, the resource control terminal apparatus according to claim 4, and the program code according to claim 12 can be used, or the resource control terminal apparatus according to claim 5 and the program code according to claim 13 can be used.

The resource control terminal apparatus according to claim 4 is connected to another terminal device through a network to establish a distributed software environment, and includes a virtual language environment, access limit search means, and network I/F means. The access limit search means receives an access limit search request specifying an optional program ID from the program code executed in the virtual language environment, retrieves another terminal device executing the program having the program ID, transmits an encrypted access confirmation message to another terminal device through the network I/F means, receives and decrypts an encrypted access confirmation reply message from another terminal device through the network I/F means, and answers the access limit search request from the program code executed in the virtual language environment according to the decrypted access confirmation reply message.

In this resource control terminal apparatus, the program code according to claim 12 is executed. The program code is executed in a virtual language environment of a resource control terminal, and specifies a program ID indicating another program and transmits an access limit search request to the access limit search means when an access request is received from the other program, receives a reply to the access limit search request, and determines whether or not the access request can be accepted based on the reply. With the above mentioned configuration, the application can confirm the intention of the user in a desired terminal device.

The resource control terminal apparatus according to claim 5 is connected to another terminal device through a network to establish a distributed software environment, and includes a virtual language environment, access limit search means, and network I/F means. The access limit search means receives an access limit search request specifying a profile ID from a program code executed in the virtual language environment, retrieves a terminal device having a right to permit access corresponding to a profile ID, transmits an encrypted access confirmation message to a terminal device having a right to permit access through the network I/F means, receives and decrypts an encrypted access confirmation reply message from a terminal device having a right to permit access through the network I/F means, and answers the access limit search request from the program code executed in the virtual language environment according to the decrypted access confirmation reply message.

In this resource control terminal apparatus, a program code according to claim 13 is executed. This program code is executed in a virtual language environment of a resource control terminal, and specifies a profile and transmits an access limit search request to the access limit search means when an access request is received from the other program, receives a reply to the access limit search request, and determines whether or not the access request can be accepted based on the reply. With the configuration, the intention of the user can be confirmed in the terminal device which is normally used by a user having a right to access data.

Furthermore, to solve the problem of inconvenient process relating to the above mentioned right to permit access, a user intention confirmation request is broadcast to a plurality of terminals, and a result obtained from an answering terminal is adopted. In this method, to avoid the conflict among a plurality of answers, the system according to claim 7 is used. This system is configured by at least one GUI-equipped terminal apparatus connected to at least one resource control terminal apparatus. The resource control terminal apparatus transmits an access confirmation message to the GUI-equipped terminal apparatus through broadcast. The GUI-equipped terminal apparatus transmits an access limit confirmation receipt message only when an access confirmation message is received when a user directly operates the GUI-equipped terminal apparatus and when an access confirmation reply message from another GUI-equipped terminal apparatus is not received. Then, the GUI-equipped terminal apparatus broadcasts an access confirmation reply message by performing a GUI displaying process and confirming the intention of the user. Thus, only the result of the terminal first issuing a reply message in a plurality of users having a right to permit access comes to be effect, thereby immediately terminating the dialog in the other terminal.

Finally, the program code according to claim 14 is used to perform a reserving process without fail even if a user is absent at a predetermined time. The program code is executed in the virtual language environment of the resource control terminal apparatus according to claim 3, 4, or 5. When an access right confirmation request is received from another program, an access limit search request is issued in the same procedure as the access confirmation request. According to the reply, it is determined whether or not access requested by the access right confirmation request can be accepted. When this program code is used, an application transmits an access right confirmation request to the program code when a reservation is made so that the program code can issue an access limit search request in the same procedure as the access confirmation request, thereby confirming the intention of the user through dialog. As a result, a confirmation result is used when an actual access request is transmitted at a reserved and predetermined time, thereby performing the reserved operation without fail.

### BRIEF DESCRIPTION OF THE DRAWINGS

FIG. 1 is a block diagram showing functions of a network system according to first, third, and fourth embodiments of the present invention;

FIG. 2 shows an image of a GUI on a display screen according to the present invention or the conventional technology;

FIG. 3 is a table contained in a modem control program according to the first embodiment of the present invention;

FIG. 4 is a block diagram showing functions of a network system according to the second embodiment of the present invention;

FIG. 5 is a table contained in a modem control program according to the second embodiment of the present invention;

FIG. 6 shows a configuration of GUI display means according to the third embodiment of the present invention;

FIG. 7 shows an image of the GUI on the display screen according to the third embodiment of the present invention; and

FIG. 8 is a block diagram showing functions of the conventional network system.

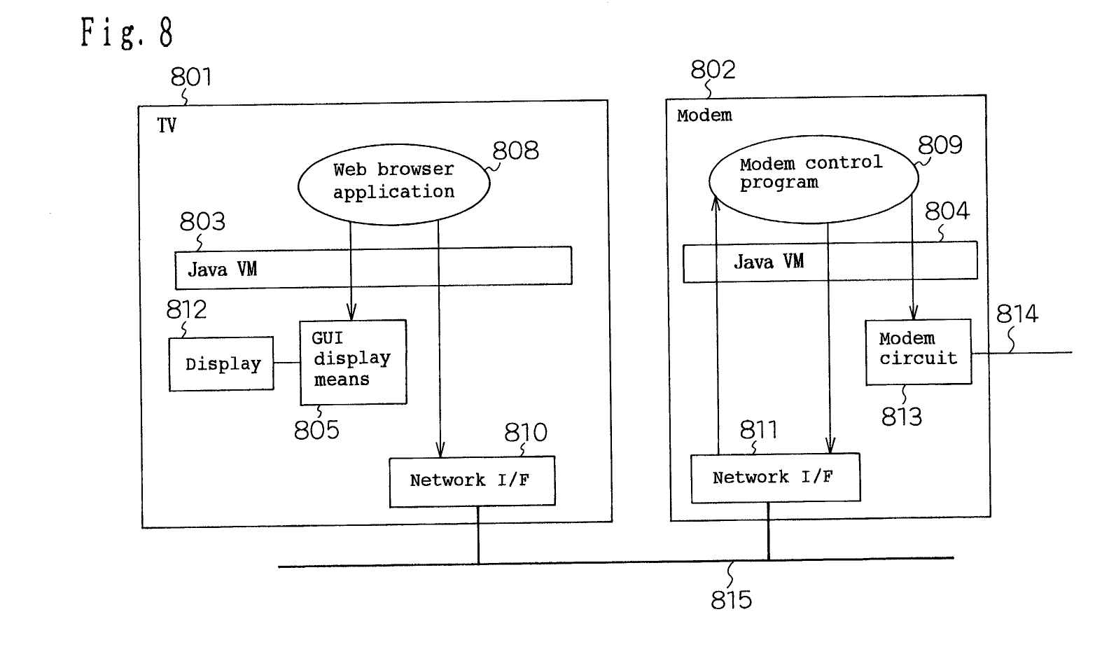

[Description of Symbols]

101 TV

102 Modem

103 JavaVirtualMachine

104 JavaVirtualMachine

105 GUI display means

106 Access limit confirmation means

107 Access limit search means

108 Web browser application

109 Modem control program

110 Network I/F

111 Network I/F

112 Display

113 Modem circuit

114 Public network

115 Network

201 Image on the display

202 Application window

203 Dialog window

204 Button

205 Button

206 Confirmation message inquiring a user

301 Access management table

401 TV

402 Modem

403 JavaVirtualMachine

404 JavaVirtualMachine

405 GUI display means

406 Access limit confirmation means

407 Access limit search means

408 Web browser application

409 Modem control program

410 Network I/F

411 Network I/F

412 Display

413 Modem circuit

414 Public network

415 Network

416 TV

417 JavaVirtualMachine

418 GUI display means

419 Access limit confirmation means

420 Display

421 Network I/F

422 Profile ID accumulation memory

423 Profile ID accumulation memory

501 Access management table

601 Drawing means

602 Drawing means

603 Input

604 Input

605 Output

606 Output

607 Compound means

701 Image on the display

702 Application window

703 Dialog window

704 Button

705 Button

706 Confirmation message inquiring a user

801 TV

802 Modem

803 JavaVirtualMachine

804 JavaVirtualMachine

805 GUI display means

808 Web browser application

809 Modem control program

810 Network I/F

811 Network I/F

812 Display

813 Modem circuit

814 Public network

815 Network

### DETAILED DESCRIPTION OF THE PREFERRED EMBODIMENTS

(Embodiment 1)

A first embodiment of the present invention will be described below by referring to the attached drawings.

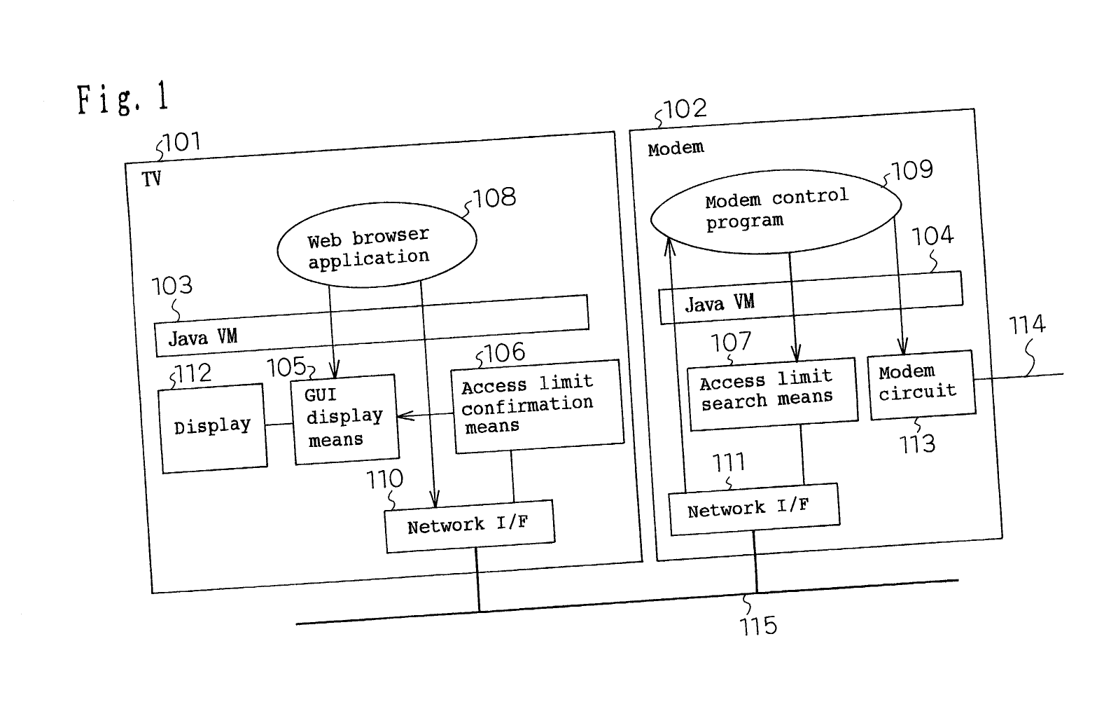

FIG. 1 shows a configuration of a network system according to the first embodiment of the present invention. The present embodiment has contents described in claims 1, 3, 4, 6, 11, and 12. The present network system is configured by connecting a TV 101 which is a GUI-equipped terminal apparatus to a modem 102 which is a resource control terminal apparatus through a network 115. The TV 101 and the modem 102 can transmit and receive a message to and from each other through networks I/F 110 and 111.

The TV 101 comprises a display 112, GUI display means 105, access limit confirmation means 106, and the network I/F 110. Furthermore, the TV 101 is provided with a JavaVirtualMachine (hereinafter referred to as JavaVM) 103 as a virtual language environment to perform a Web browser application 108 interpreted and executed by the JavaVM 103. Although not shown in FIG. 1, the TV 101 is also provided with remote-controlled reception means, and can receive an instruction from a user according to the GUI displayed on the display 112 by the GUI display means 105.

The modem 102 comprises access limit search means 107, a modem circuit 113, and the network I/F 111. Furthermore, the modem 102 is provided with a JavaVM 104 as a 987 virtual language environment to execute a modem control program 109 interpreted and executed by the JavaVM 104. The modem circuit 113 is connected to a public network 114, connects a line when a telephone number is specified, and accesses Internet. The modem control program 109 receives a request from another Java program in the network through the JavaVM 104, processes and determines this request, and operates the modem circuit 113, thereby performing the operation of sharing the function of the modem circuit 113 with other Java programs in the network. Furthermore, the modem circuit 113 does not directly publish the API through the JavaVM to other Java programs in the network, and is directly controlled only by the modem control program 109.

The modem control program 109 according to the present embodiment is an example of the resource control program code of the present invention, and the modem circuit 113 according to the present embodiment is an example of the resources of the present invention. The TV 101 according to the present embodiment is an example of the GUI-equipped terminal apparatus of the present invention, and the JavaVM 103 according to the present embodiment is an example of the virtual language environment of the present invention. The Web browser application 108 according to the present embodiment is an example of the application of the present invention. The network I/F 110 according to the present embodiment is an example of the network I/F means of the present invention. The display 112 according to the present embodiment is an example of the display means of the present invention. The modem 102 according to the present embodiment is an example of the resource control terminal apparatus of the present invention. The modem control program 109 according to the present embodiment is an example of the resource control program code of the present invention. The JavaVM 104 according to the present embodiment is an example of the virtual language environment of the present invention. The network I/F 111 according to the present embodiment is an example of the network I/F means of the present invention. The TV 101 and the modem 102 according to the present embodiment are examples of the network system of the present invention. The JavaVM 103 according to the present embodiment is an example of the first virtual language environment of the present invention. TheJavaVM 104 according to the present embodiment is an example of the second virtual language environment of the present invention. The network I/F 110 according to the present embodiment is an example of the first network I/F means of the present invention. The network I/F 111 according to the present embodiment is an example of the second network I/F means of the present invention.

According to the embodiment with the above mentioned configuration, the procedure of accessing Internet by the Web browser application 108 through the public network 114 using the modem circuit 113 is described below, and the operation of the network system according to the present invention is also described below.

The Web browser application 108 is an application performed by the JavaVM 103, and issues a request to display an operation window of the Web browser to the GUI display means 105 through the JavaVM 103 when the application is activated. The request is issued by the function invoking method of the GUI display means 105 by Java. As a result, the window of the Web browser application 108 is displayed on the display 112.

Then, at an instruction of a user, the Web browser application 108 starts the procedure of requesting optional data through Internet. Since the Web browser application 108 requires a connection to a public network in this requesting procedure, a remote terminal is invoked through the network 115 by invoking an open request method in which the modem control program 109 is requested to specify a telephone number through JavaVM. As a result, an open request message is transmitted to the modem control program 109.

At this time, the Web browser application 108 adds the program ID of itself as an argument of the method, and the open request message is accompanied with the program ID of the Web browser application 108. The open request message corresponds to the access request according to the present embodiment.

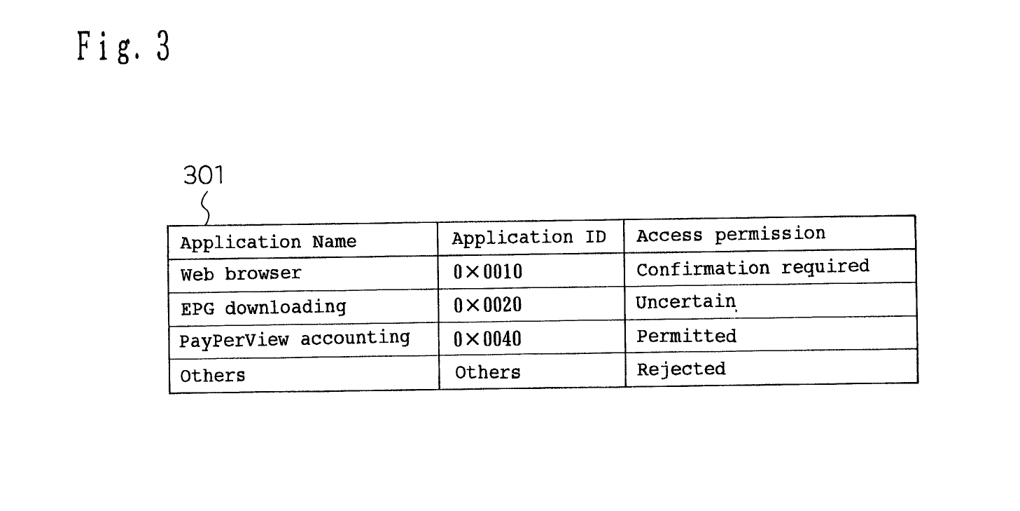

According to the present embodiment, the modem control program 109 includes an access management table 301 as shown in FIG. 3. The table stores an application name, an application ID, and the type of corresponding access control.

After receiving an open request message from the Web browser application 108, the modem control program 109 refers to the access management table 301, and specifies the type of access control for the application which has issued the open request message. Relating to the type of access control shown in FIG. 3, ‘confirmation required’ indicates that user confirmation is required through dialog, ‘uncertain’ indicates that data or information is uncertain, ‘permitted’ indicates that access is constantly permitted, and ‘not permitted’ indicates that access is constantly rejected.

In this example, since the type of access control to the Web browser is ‘confirmation requested’, the procedure of confirming the intention of a user is started by the modem control program 109. In this procedure, the modem control program 109 issues an access limit search request to the access limit search means 107 to request to confirm through dialog on the TV 101 in which the Web browser application 108 is executed.

Upon receipt of the request, the access limit search means 107 generates an encrypted access confirmation message. The contents of the access confirmation message are character strings displayed to the user, and user selection items YES or NO.

Then, the access limit search means 107 retrieves the application ID contained in the open request message using the function provided in a common distributed network environment such as a registry service, etc. of the network, detects the TV 101 which is a terminal executing the Web browser application 108, and transmits it to the TV 101 through the network I/F 111, thereby requesting the confirmation of the intention of the user through dialog on the TV 101.

In the TV 101 which has received an encrypted access confirmation message through the network I/F 110, the access limit confirmation means 106 receives and decrypts the message. Then, according to the decrypted access confirmation message, the access limit confirmation means 106 requests the GUI display means 105 to draw the dialog. This request is directly issued to the GUI display means 105 without JavaVM. As described above, the access confirmation message contains a confirmation message inquiring the user whether or not the Web browser can be connected to the modem.

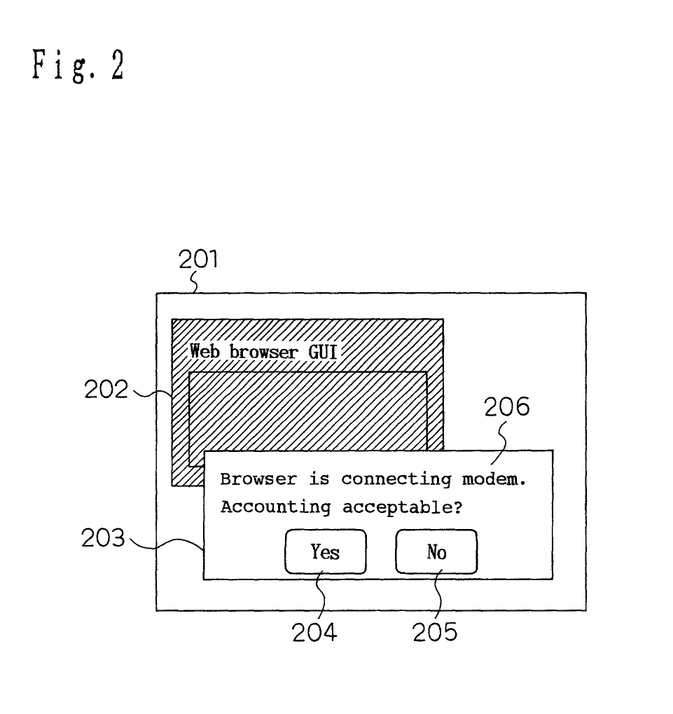

FIG. 2 shows the image displayed on the display 112. Reference numeral 201 denotes an image on the display. Reference numeral 202 denotes an application GUI window drawn through the JavaVM 103 by the Web browser application 108. Reference numeral 203 denotes a dialog window drawn by the access limit confirmation means 106. Reference numerals 204 and 205 denote buttons in the dialog window 203. Reference numera l206 denotes a displayed confirmation message inquiring a user.

After confirming the intention of a user (practically YES) whether or not the connection of the modem is permitted using the dialog window 203 shown in FIG. 2, the access limit confirmation means 106 transmits the result as the encrypted access confirmation reply message of ‘YES’ to the modem 102 through the network I/F 110.

Finally, the encrypted access confirmation reply message is received and decrypted by the access limit search means 107 through the network I/F 111. Based on the result, the access limit search means 107 returns an answer that the access is permitted in response to the access limit search request from the modem control program 109 in the first step.

The modem control program 109 confirms the permission of the user in the above mentioned procedure. Then, the modem control program 109 actually connects lines using the modem circuit 113.

As described above, since the TV 101 displays dialog without JavaVM according to the present embodiment, the intention of a user can be confirmed for security even through the network 115. In addition, since the Web browser application 108 is not related to the process of confirming the intention of a user, a program can be prepared only by obtaining the method of a line open request which is a method open to the modem control program 109 independent of the details of the above mentioned process.

Furthermore, since the process of confirming the intention of a user is performed without JavaVM, authentication can be performed between the access limit confirmation means 106 and the access limit search means 107 to further improve the reliability.

Although a control signal can be transmitted and received between the modem circuit 113 and the modem control program 109 through the JavaVM 104 according to the present embodiment, the modem circuit 113 and the modem control program 109 are normally provided and operated in pairs so that it is not necessary to publish the control signal. Therefore, according to the present embodiment, the modem circuit 113 does not directly publish the API through the JavaVM 104 to other Java programs in the network 115, but only the modem control program 109 can directly control it. Obviously, the control signal transmitted through the API can be encrypted with high reliability and preferable configuration. When the control signal can be protected against a malicious program such as a virus program, etc. it can be processed in public.

Although the modem circuit 113 and the modem control program 109 are provided in the same terminal according to the present embodiment, the present invention is not limited to this configuration. That is, although the resources and the resource control program are provided in different terminals, the similar system can be applied if the resource control program allows the functions of the resources to be shared among other Java programs in the network, the resources do not directly publish the API through JavaVM to other Java programs in the network, and it can be directly controlled only from the resource control program.

Furthermore, the virtual language environment according to the present invention can be realized by not only JavaVM according to the present embodiment, but also any other virtual languages which can invoke the functions of a remote terminal in a distributed network environment.

Furthermore, according to the present embodiment, a modem is used as an example of a resource and a resource control terminal. However, for example, access control for viewing or listening toll contents in a digital TV system can be performed in a similar method. That is, the present invention can be applied if a user can permit access for each program.

(Embodiment 2)

The second embodiment of the present invention will be described below by referring to the attached drawings.

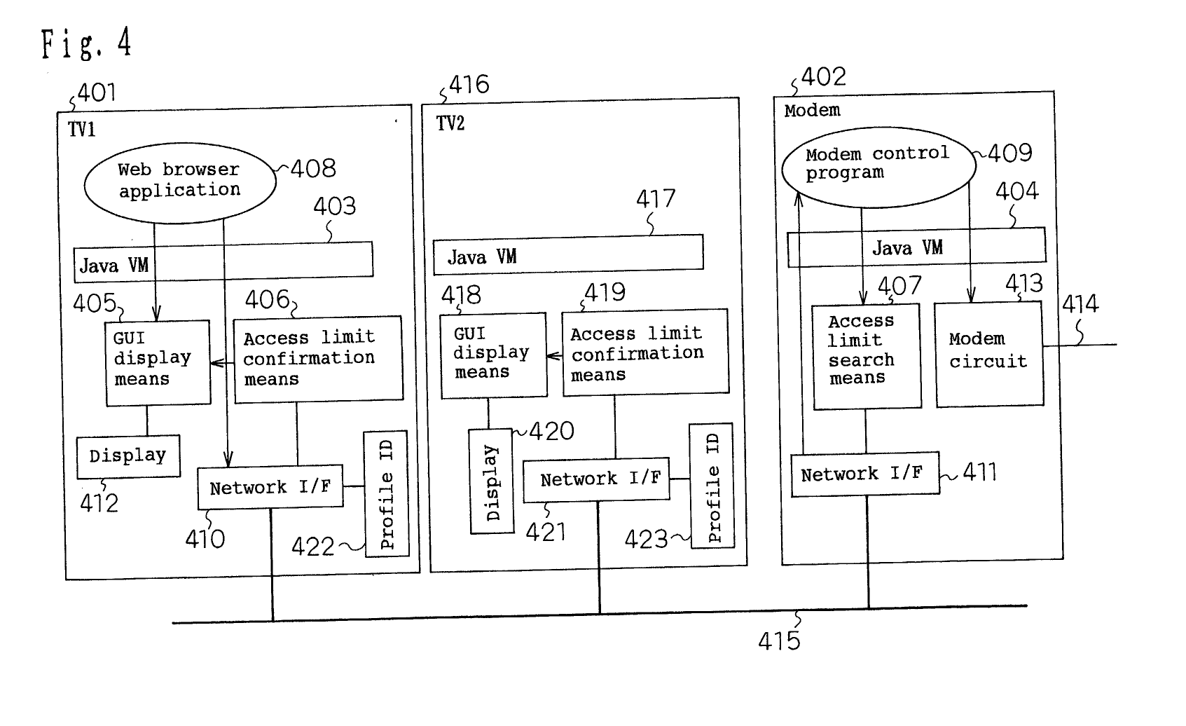

FIG. 4 shows the configuration of the network system according to the second embodiment of the present invention. The present embodiment includes the contents of the invention according to claims 1, 5, 6, 7, and 13. This network system is configured by two TV 401 and TV 416 which are GUI-equipped terminal apparatuses connected to a modem 402 which is a resource control terminal apparatus through a network 415. The TV 401, the TV 416, and the modem 402 can transmit and receive a message to and from one another through networks I/F 410, 421, and 411.

The TV 401 comprises a display 412, GUI display means 405, access limit confirmation means 406, and the network I/F 410. Furthermore, the TV 401 is provided with JavaVM 403 as a virtual language environment, and can perform a Web browser application 408 interpreted and executed by the JavaVM 403. In addition, the network I/F 410 is provided with profile ID accumulation memory 422, and can read the profile ID accumulated in the profile ID accumulation memory 422 from other terminals through the network. Although not shown in the attached drawings, it is also provided with remote-controlled reception means for receiving an instruction from a user according to the GUI displayed on the display 412 by the GUI display means 405.

The TV 416 comprises a display 420, GUI display means 418, access limit confirmation means 419, and a network I/F 421. Furthermore, the TV 416 is loaded with JavaVM 417 as a virtual language environment. However, it is assumed that the TV 416 is not currently loaded with any Java application at this moment.

In addition, profile ID accumulation memory 423 is added to the network I/F 421 so that the profile ID accumulated in the profile ID accumulation memory 423 can be read from other terminals through the network. Although not shown in the attached drawings, it is also provided with a remote-controlled reception means to receive an instruction from a user through the GUI displayed by the GUI display means 418 on the display 420.

The modem 402 comprises access limit search means 407, a modem circuit 413, and a network I/F 411. Furthermore, the modem 402 is loaded with JavaVM 404 as a virtual language environment, and can execute a modem control program 409 interpreted and executed by the JavaVM 404. The modem circuit 413 is connected to a public network 4l4, and can access Internet by connecting a line by specifying a telephone number.

The modem control program 409 receives a request from another Java program in the network through the JavaVM 404, processes and determines this request, and operates the modem circuit 413, thereby performing the operation of sharing the function of the modem circuit 413 with other Java programs in the network. Furthermore, the modem circuit 413 does not directly publish the API through the JavaVM to other Java programs in the network, and is directly controlled only by the modem control program 409.

The modem control program 409 according to the present embodiment is an example of the resource control program code of the present invention, and the modem circuit 413 according to the present embodiment is an example of the resources of the present invention. The TV 401 according to the present embodiment is an example of the GUI-equipped terminal apparatus of the present invention, and the JavaVM 403 according to the present embodiment is an example of the virtual language environment of the present invention. The Web browser application 408 according to the present embodiment is an example of the application of the present invention. The network I/F 410 according to the present embodiment is an example of the network I/F means of the present invention. The display 412 according to the present embodiment is an example of the display means of the present invention. The TV 416 according to the present embodiment is an example of the GUI-equipped terminal apparatus of the present invention. The JavaVM 417 according to the present embodiment is an example of the virtual language environment of the present invention. The network I/F 421 according to the present embodiment is an example of the network I/F means of the present invention. The display 420 according to the present embodiment is an example of the display means. The modem 402 according to the present embodiment is an example of the resource control terminal apparatus of the present invention. The modem control program 409 according to the present embodiment is an example of the resource control program code of the present invention. The JavaVM 404 according to the present embodiment is an example of the virtual language environment of the present invention. The network I/F 411 according to the present embodiment is an example of the network I/F means of the present invention. The TV 101, the TV 416, and the modem 102 are examples of the network systems of the present invention. The JavaVM 403 according to the present embodiment is an example of the first virtual language environment of the present invention. The JavaVM 417 according to the present embodiment is an example of the first virtual language environment of the present invention. The JavaVM 404 according to the present embodiment is an example of the second virtual language environment. The network I/F 410 according to the present embodiment is an example of the first network I/F means of the present invention. The network I/F 421 according to the present embodiment is an example of the first network I/Fmeans of the present invention. The network I/F 411 according to the present embodiment is an example of the second network I/F means of the present invention.

According to the embodiment with the above mentioned configuration, the procedure of accessing Internet by the Web browser application 408 through the public network 414 using the modem circuit 413 is described below, and the operation of the network system according to the present invention is also described below.

The Web browser application 408 is an application performed by the JavaVM 403, and issues a request to display an operation window of the Web browser to the GUI display means 405 through the JavaVM 403 when the application is activated. The request is issued by the function invoking method of the GUI display means 405 by Java. As a result, the window of the Web browser application 408 is displayed on the display 412.

Then, at an instruction of a user, the Web browser application 408 starts the procedure of requesting optional data through Internet. Since the Web browser application 408 requires a connection to a public network in this requesting procedure, a remote terminal is invoked through the network 415 by invoking an open request method in which the modem control program 409 is requested to specify a telephone number through JavaVM 403. As a result, an open request message is transmitted to the modem control program 409. The open request message corresponds to an access request described in the embodiment.

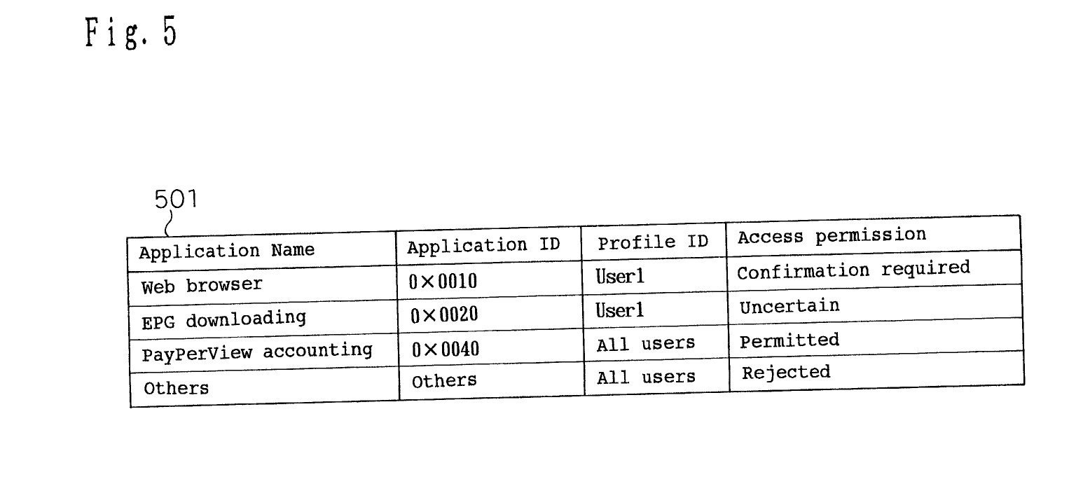

According to the present embodiment, the modem control program 409 includes an access management table 501 as shown in FIG. 5. The table stores an application name, an application ID, a profile ID having a permission right, and the type of access control corresponding to the profile ID.

After receiving an open request message from the Web browser application 408, the modem control program 409 refers to the access management table 501, and specifies the profile ID having the permission right for the application which has issued the open request message, and the type of access control corresponding to the profile ID.

In FIG. 5, the profile ID having a permission right is ‘User1’ for which access control of ‘confirmation required’ indicating that the confirmation of a user through dialog is required is specified. Since the type of access control for the Web browser application 408 is ‘confirmation required’, the confirmation procedure for the profile ‘User1’ is started by the modem control program 409. In this procedure, the modem control program 409 issues an access limit search request with the profile ‘User1’ specified to the access limit search means 407.

The access limit search means 407 receives the request, and generates an encrypted access confirmation message. The contents of the access confirmation message are character strings displayed to the user, and ‘YES’ or ‘NO’ as user selection items.

Then, the access limit search means 407 searches the profile ID accumulated in the profile ID accumulation memory of each terminal in the network, and specifies the terminal accumulating the ‘USER1’.

A profile ID refers to an ID specifying a user and his or her right. When a user has a right to use an important function of a terminal, the user has an ID code accumulated in the profile ID accumulation memory of the terminal. Information about the administrator of an appliance, the main user of the appliance, etc. is added to the profile ID, or the rules for management as a user account using a password, etc. are defined separately for the profile ID for convenient use in the network.

Described below first will be the case in which the ‘USER1’ is recorded only in the profile ID accumulation memory 422 as the first case of the present embodiment. In this case, the access limit search means 407 transmits an access confirmation message only to the TV 401, that is, the terminal in which this profile has been detected. Thus, in the same process as in the first embodiment of the present invention, the GUI shown in FIG. 2 is displayed on the display 412 through the access limit confirmation means 406 and the GUI display means 405 to confirm the intention of the user. As a result, an access confirmation reply message is transmitted to the modem 402, thereby confirming the intention of the user. Since this case is almost the same as the case in the first embodiment of the present invention, the detailed explanation is omitted here.

Described below will be the second case of the present embodiment in which the ‘USER1’ is recorded in both profile ID accumulation memory 422 and 423. In this case, there are a plurality of terminals having profiles. Therefore, the access limit search means 407 transmits an encrypted access confirmation message to both TV 401 and TV 416 in which profiles have been detected (that is, broadcasting), and requests confirmation of the intention of a user through dialog. Thus, in the same process as in the first embodiment of the present invention, the image 201 shown in FIG. 2 is displayed on the display 412, and the image obtained by excluding the application window 202 from the image 201 is displayed on the display 420 in the TV 401 and TV 416.

When the user answers the dialog from either the TV 401 or the TV 416, the access limit confirmation means 406 or the access limit confirmation means 419 encrypts an access confirmation reply message in response to the access confirmation message, transmits the message to the modem 402, and broadcasts the information to the terminals having the same profile, that is, to the TV 401 or the TV 416.

At this time, in the terminal in which the user does not answer the dialog, the display of the dialog and the confirmation of the intention of the user are stopped when the access confirmation reply message is received. Therefore, the modem 402 does not receive a plurality of access confirmation reply messages, thereby avoiding the conflict.

Finally, the encrypted access confirmation reply message is received and decrypted by the access limit search means 407 through the network I/F 411. Based on the result, the access limit search means 407 returns an answer as to whether or not the access is permitted in response to the access limit search request from the modem control program 409 in the first step. The modem control program 409 confirms the permission of the user in the above mentioned procedure. Then, the modem control program 409 actually connects lines using the modem circuit 413.

As described above, the present embodiment not only has the function of the first embodiment of the present invention, but also has an access permission right even when there are a plurality of terminals, selectively displays a dialog window on a terminal most convenient to the user, and obtains a unique result by avoiding a conflict with a simple configuration even when there are a plurality of terminals to display information on.

Although a control signal can be transmitted and received between the modem circuit 413 and the modem control program 409 through the JavaVM 404 according to the present embodiment, the modem circuit 413 and the modem control program 409 are normally provided and operated in pairs, it is not necessary to publish the control signal. Therefore, according to the present embodiment, the modem circuit 413 does not directly publish the API through the JavaVM 404 to other Java programs in the network 415, but only the modem control program 409 can directly control it. Obviously, the control signal transmitted through the API can be encrypted with high reliability and preferable configuration. When the control signal can be protected against a malicious program such as a virus program, etc. it can be processed in public.

Although the modem circuit 413 and the modem control program 409 are provided in the same terminal according to the present embodiment, the present invention is not limited to this configuration. That is, although the resources and the resource control program are provided in different terminals, the similar system can be applied if the resource control program allows the functions of the resources to be shared among other Java other Java programs in the network, the resources do not directly publish the API through JavaVM to other Java programs in the network, and it can be directly controlled only by the resource control program.

Furthermore, the virtual language environment according to the present invention can be realized by not only JavaVM according to the present embodiment, but also any other virtual languages which can invoke the functions of a remote terminal in a distributed network environment.

(Embodiment 3)

The third embodiment of the present invention will be described below by referring to the attached drawings.

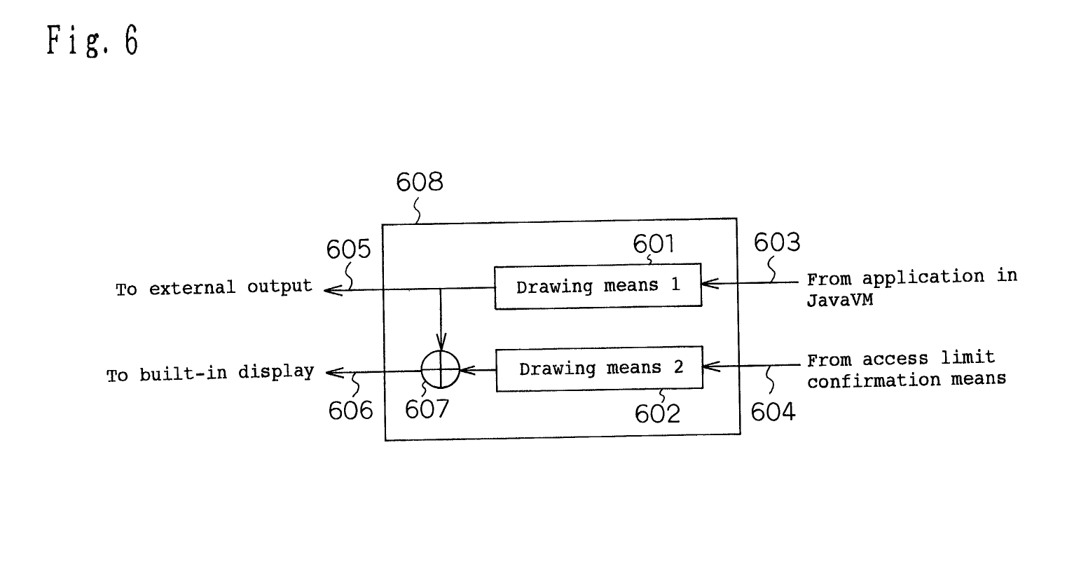

The present embodiment will be described by referring FIG. 1 again. The present embodiment is different from the first embodiment in that a reservation is made prior to an issue of an actual resource access request, and that the detailed implementation of the GUI display means 105 is performed as of GUI display means 608 especially shown in FIG. 6. The present embodiment includes the contents embodying the invention described in claims 2, 3, 4, 6, 11, and 14.

An embodiment with the above mentioned configuration will be described below. According to the embodiment, the Web browser application 108 has an Internet reservation cyclic function, and the sequence of accessing Internet through the public network 114 using the modem circuit 113 is reserved for a specified time. The operations of the network system having the GUI-equipped terminal apparatus, the resource control terminal apparatus, and the network system according to the present invention are described below.

The Web browser application 108 is an application performed by the JavaVM 103. When it is activated, it requests the GUI display means 105 to display an operation window of the Web browser through the JavaVM 103. This process is performed in the function invoking method of the GUI display means 105 by Java. As a result, a window of the Web browser application 108 is displayed on the display 112.

When a requesting sequence for optional data in Internet is reserved by the Web browser application 108 at an instruction of a user, the Web browser application l08 requires a connection to a public network during the execution of the sequence. Therefore, an access right confirmation requesting method is invoked for an open request for confirmation as to whether or not an open requesting method with a telephone number for the modem control program 109 specified can be performed through JavaVM. As a result, an access right confirmation request message in response to the open request is transmitted to the modem control program 109.

When the modem control program 109 receives an access right confirmation request message to an open request, it starts a procedure of confirming a user intention which is almost the same as that performed when an open request message is received without specifying the time as described in the above mentioned embodiment.

That is, the access management table 301 contained in the modem control program 109 is referred to, and the type of access control of the application which has issued the open request message is specified. In this example, since the type of access control of the Web browser application 108 is ‘confirmation required’, the procedure of confirming the intention of a user is started by the modem control program 109. In this procedure, the modem control program 109 issues an access limit search request to the access limit search means 107 to confirm the intention through the dialog on the TV 101 executing the Web browser application 108. Upon receipt of the request, the access limit search means 107 generates an encrypted access confirmation message. The contents of the access confirmation message are character strings displayed to the user, and user selection items YES or NO.

Then, the access limit search means 107 retrieves the application ID contained in the open request message using the function provided in a common distributed network environment such as a registry service, etc. of the network, detects the TV 101 which is a terminal executing the Web browser application 108, and transmits it to the TV 101 through the network I/F 111, thereby requesting the confirmation of the intention of the user through dialog on the TV 101.

In the TV 101 which has received an encrypted access confirmation message through the network I/F 110, the access limit confirmation means 106 receives and decrypts the message. Then, according to the decrypted access confirmation message, the access limit confirmation means 106 requests the GUI display means 105 to draw the dialog. This request is directly issued to the GUI display means 105 without JavaVM. The access confirmation message contains a confirmation message inquiring the user whether or not it can be reserved that the Web browser is connected to the modem. (Therefore, the contents of the message can be different between when the modem control program 109 receives an open request message and when it receives an access right confirmation request message in response to an open request.)

FIG. 2 shows the image displayed on the display 112. Reference numeral 201 denotes an image on the display. Reference numeral 202 denotes an application GUI window drawn through the JavaVM 103 by the browser 108. Reference numeral 203 denotes a dialog window drawn by the access limit confirmation means 106. Reference numerals 204 and 205 denote buttons in the dialog window 203. Reference numeral 206 denotes a displayed confirmation message.

After confirming the intention of the user (practically YES) whether or not the connection reservation of the modem is permitted using the dialog window 203 shown in FIG. 2, the access limit confirmation means 106 transmits the result as the encrypted access confirmation reply message of ‘YES’ to the modem 102 through the network I/F 110.

Finally, the encrypted access confirmation reply message is received and decrypted by the access limit search means 107 through the network I/F 111. Based on the result, the access limit search means 107 returns an answer that the access is permitted in response to the access limit search request from the modem control program 109 in the first step. The modem control program 109 confirms the access reservation permission of the user in the above mentioned procedure, and answers that the access is permitted in response to the access right confirmation request message for the open request. Upon receipt of the permission, the Web browser application 108 reserves a sequence (if it is not permitted, some resources may not be accessed, and no reservation is made). According to the above mentioned procedure, the Web browser confirms an access right, and when a reservation is made, it is determined whether or not the Web browser application 108 can access the modem 102. The message transmitted by the Web browser application 108 to the modem control program 109 is an access right confirmation request message, not an open request message. Therefore, the line of a modem is not opened when a reservation is made, but the line of the modem is actually opened when the Web browser application 108 starts the reservation sequence and issues an open request message.

As described above, the present embodiment has an excellent feature that the system of reserving an access right can be added without changing a terminal only by adding the above mentioned function to the Web browser application 108 and the modem control program 109 in the network system according to the first embodiment of the present invention.

Described below will be the detailed operations of the GUI display means 105. The GUI display means 105 is configured like the GUI display means 608 shown in FIG. 6. In FIG. 6, the GUI display means 608 comprises drawing means 601, drawing means 602, and compound means 607, and has four terminals of input 603, input 604, output 605, and output 606. The input 603 is connected to the method from the application of the JavaVM 103, the input 604 is connected to the access limit confirmation means 106, the output 605 is connected to an external output terminal outputting a picture from the TV 101 omitted in FIG. 1 to an external device, and the output 606 is connected to the display 112. The drawing means 601 and 602 receive an instruction to draw an image and draw images respectively, and the compound means 607 compounds these two images by an optional image compounding operation.

With the above mentioned configuration, the TV 101 can display the image 201 as shown in FIG. 2 on the display 112. At this time, an image can be output to an external output terminal by excluding the dialog window 203 drawn by the access limit confirmation means 106 from the image 201.

With the above mentioned configuration, the interruption of an unintended OSD through a network is limited only to the display 112. Therefore, an unexpected failure in a recording process can be successfully avoided although a VTR, etc. is connected to an external output terminal of the TV 101.

(Embodiment 4)

The fourth embodiment of the present invention will be described below by referring to the attached drawings. The present embodiment specifically includes the contents embodying the descriptions in claims 1, 3, 4, 6, 8, 9, 11, and 12.

The present embodiment will be described below by referring to FIG. 1. The difference between the present embodiment and the first embodiment is the difference in the contents of the access confirmation message and the access confirmation reply message transmitted and received between the TV 101 and the modem 102. Practically, in the first embodiment, the contents of the access confirmation message are the character string displayed to a user, and the data string of the user selection items represented by YES or NO. In the present embodiment, they are the bit map data of dialog indicating the selection. The contents of the access confirmation reply message in the first embodiment are data indicating YES or NO as an answer of a user. In the present embodiment, they are the coordinates selected by the user in the dialog using a pointer.

According to the embodiment with the above mentioned configuration, the network system according to the present invention like the embodiment according to the first embodiment confirms the intention of a user by the image shown in FIG. 2. In the present embodiment, the access confirmation reply message received by the access limit search means 107 does not contain data indicating YEW or NO as an answer of a user. Therefore, the access limit search means 107 interprets which button the user has pressed according to the information obtained when the bit map of the dialog transmitted using an access confirmation message is used, and the coordinates selected by the user in the dialog contained in an access confirmation reply message, and then confirms the intention YES or NO of the user.

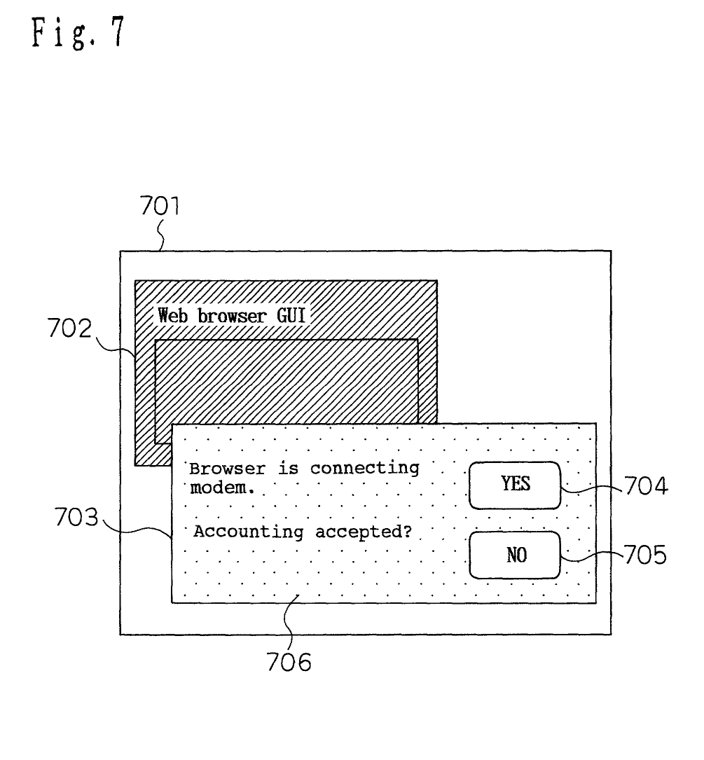

Furthermore, in the present embodiment, the bit maps generated by the access limit search means are different in the graphic representation using the positions of buttons, the texture of the background, etc. FIG. 7 shows another example of an image of the display for the user.

As described above, the present embodiment has the same functions as the first embodiment, does not contain information indicating the meaning by a message itself, but uses information changed frequently so that the information cannot be automatically analyzed by a program using texture, etc., thereby preventing wire tapping and forgery, and protecting the system against virus programs, etc.

Furthermore, a computer-processible medium storing a program and/or data used to direct a computer to perform all or a part of the functions of all or a part of means of the resource control terminal apparatus or the GUI-equipped terminal apparatus according to the present invention also belongs to the present invention.

Furthermore, an information aggregate which is a program and/or data used to direct a computer to perform all or a part of the functions of all or a part of means of the resource control terminal apparatus or the GUI-equipped terminal apparatus according to the present invention also belongs to the present invention.

Additionally, a computer-processible medium storing all or a part of steps of the above mentioned resource control program code of the resource control terminal apparatus according to the present invention also belongs to the present invention.

Furthermore, the data according to the present invention includes a data structure, a data format, the type of data, etc. The medium according to the present invention includes a recording medium such as ROM, etc., a transmission medium such as Internet, etc., and a transmission medium such as a light, an electric wave, a sound wave, etc. The medium according to the present invention includes a recording medium for recording, for example, a program and/or data, a transmission medium for transmitting a program and/or data, etc. Additionally, ‘computer-processible’ according to the present invention indicates that, for example, a recording medium such as ROM, etc. stores data that can be read by a computer, a transmission medium can store a program and/or data to be transmitted and then processed by a computer, etc. Furthermore, an information aggregate includes software such as a program and/or data, etc.

Furthermore, a program recording medium for recording a program and/or data used to direct a computer to perform all or a part of the functions of all or a part of means, lines and I/F of the TV, the TV1, TV2 and the modem according to the above mentioned embodiment can be a program recording medium which can be read by a computer, and the read program and/or data can cooperate with the computer to perform the functions.

As described above, the present invention can provide a GUI-equipped terminal apparatus, a resource control terminal apparatus, a network system, a medium, and an information aggregate capable of safely displaying dialog on a remote GUI-equipped terminal, and allowing a user without fail to specify an access limit for any resources in a network.

The present invention can further provide a GUI-equipped terminal apparatus, a resource control terminal apparatus, a network system, a medium, and an information aggregate capable of generating an application in a virtual language based on a published specification.

Furthermore, the present invention can provide a GUI-equipped terminal apparatus, a resource control terminal apparatus, a network system, a medium, and an information aggregate capable of displaying dialog to a user having an access permission right, and avoiding a conflict for an answer when there are a plurality of users having access permission rights.

Additionally, the present invention can provide a GUI-equipped terminal apparatus, a resource control terminal apparatus, a network system, a medium, and an information aggregate capable of avoiding a by-product by an interruption display of dialog.

Furthermore, the present invention can provide a GUI-equipped terminal apparatus, a resource control terminal apparatus, a network system, a medium, and an information aggregate capable of performing a reserving process without fail although a user is absent at a predetermined time.

What is claimed is:

1. A GUI-equipped terminal apparatus which is connected to another terminal device through a network, and forms a distributed software environment, comprising:
GUI display means;
a virtual language environment which is a program execution environment in which a program code generated in a predetermined language can be executed independent of a specific type of apparatus;
access limit confirmation means of operating in another execution environment different from said virtual language environment; and
network I/F means, wherein:
said network I/F means exchanges information with another terminal device through the network;
said GUI display means displays an application GUI at an instruction from an application executed in said virtual language environment, and displays an access limit confirmation GUI at an instruction from said access limit confirmation means; and
said access limit confirmation means receives an access confirmation message encrypted by another terminal device through said network I/F means, and transmits an encrypted access confirmation reply message to said other terminal device through said network I/F means.

2. The GUI-equipped terminal apparatus according to claim 1, further comprising display means of displaying an image drawing signal output from said GUI display means on a monitor, wherein:
said GUI display means has an external output terminal;
said GUI display means displays the application GUI at an instruction from an application executed in said virtual language environment only on said display means or both said display means and said external output terminal; and
when an instruction from said access limit confirmation means is received, said access limit confirmation GUI is displayed only on said display means, and not on said external output terminal.

3. A resource control terminal apparatus which is connected to another terminal device through a network, and forms a distributed software environment, comprising:
a virtual language environment which is a program execution environment in which a program code generated in a predetermined language can be executed independent of a specific type of apparatus;
access limit search means of operating in another execution environment different from said virtual language environment; and
network I/F means, wherein:
said network I/F means exchanges information with said another terminal device through said network;
said access limit search means receives and encrypts an access limit search request from an resource control program code executed in said virtual language environment, and transmits the access confirmation message to said other terminal device through said network I/F means, receives and decrypts an encrypted access confirmation reply message from said other terminal device through said network I/F means; and
said access limit search means answers said access limit search request from the resource control program code according to said decrypted access confirmation reply message.

4. The resource control terminal apparatus according to claim 3, wherein:
said access limit search means receives an access limit search request specifying an optional program ID from said resource control program code;
said access limit search means retrieves said other terminal device in which a program having said program ID is being executed;
said access limit search means transmits said encrypted access confirmation message to said retrieved other terminal device through said network I/F means;
said access limit search means receives an encrypted access confirmation reply message from said retrieved other terminal device through said network I/F means, and decrypts said encrypted access confirmation reply message; and
said access limit search means answers an access limit search request from said resource control program code according to said decrypted access confirmation reply message.

5. The resource control terminal apparatus according to claim 3, wherein:
said access limit search means receives an access limit search request specifying a profile ID from said resource control program code;
said access limit search means retrieves a terminal device having a permission right corresponding to said profile ID;
said access limit search means transmits an encrypted access confirmation message to a terminal device having said permission right through said network I/F means;
said access limit search means receives an encrypted access confirmation reply message from the terminal device having said permission right through said network I/F means, and decrypts said encrypted access confirmation reply message; and
said access limit search means answers an access limit search request from said resource control program code according to said decrypted access confirmation reply message.

6. A network system, comprising:
at least one GUI-equipped terminal apparatus connected to a network; and
at least one resource control terminal apparatus connected to said network, wherein:
said GUI-equipped terminal apparatus and said resource control terminal apparatus form a distributed software environment;
said GUI-equipped terminal apparatus comprises:
GUI display means;
a first virtual language environment which is a program execution environment in which a program code generated in a predetermined language can be executed independent of a specific type of apparatus;
access limit confirmation means of operating in another execution environment different from said first virtual language environment; and
first network I/F means, wherein:
said resource control terminal apparatus comprises:
a second virtual language environment which is a program execution environment in which a program code generated in said predetermined language can be executed independent of a specific type of apparatus;
access limit search means of operating in another execution environment different from said second virtual language environment; and
second network I/F means, wherein:
said first network I/F means exchanges information with said resource control terminal apparatus through said network;
said second network I/F means exchanges information at least with said GUI-equipped terminal apparatus through said network;
said access limit search means receives an access limit search request from a resource control program code executed in said second virtual language environment, and encrypts the request, and transmits said access confirmation message to said GUI-equipped terminal apparatus through said second network I/F means;
said access limit confirmation means receives said encrypted access confirmation message from said access limit search means through said first network I/F means, decrypts said access confirmation message, and outputs the decrypted message to said GUI display means;
said GUI display means displays an application GUI at an instruction from an application executed in said first virtual language environment, and displays an access limit confirmation GUI upon receipt of said access confirmation message from said access limit confirmation means;
said GUI display means outputs an input to said access limit confirmation GUI to said access limit confirmation means;
said access limit confirmation means generates an access confirmation reply message from said input and encrypts the message, said encrypted access confirmation reply message is transmitted to said resource control terminal apparatus through said first network I/F means; and
said access limit search means receives the encrypted access confirmation reply message from said GUI-equipped terminal apparatus through said second network I/F means, decrypts the message, and answers the access limit search request from said resource control program code according to said decrypted access confirmation reply message.

7. The network system according to claim 6, wherein:
plurality of said GUI-equipped terminal apparatus is connected to a plurality of said networks;
said resource control terminal apparatus broadcasts an access confirmation message to said GUI-equipped terminal apparatus;
when said GUI-equipped terminal apparatus is directly operated by a user, does not receive another access confirmation reply message in response to said access confirmation message from said other GUI-equipped terminal apparatus, and receives said access confirmation message transmitted from said resource control terminal apparatus, said GUI-equipped terminal apparatus transmits an access limit confirmation receipt message, performs a GUI display, confirms a request of the user, and broadcasts an access confirmation reply message.

8. The network system according to claim 6 or 7, wherein:
said access confirmation message transmitted from said resource control terminal apparatus contains bit map data of a GUI image for a user selecting information about access limit requested from said application;
said access confirmation reply message transmitted from said GUI-equipped terminal apparatus contains coordinates of a position at which the user performs an action on said bit map data of said GUI image;
said resource control terminal apparatus confirms selection of a user for information about said access limit based on said coordinates of the position, and answers the access limit search request from said application based on said selection of the user.

9. The network system according to claim 8, wherein said resource control terminal apparatus changes a position or an expression of a GUI unit forming bit map data of a GUI image contained in said access confirmation message each time said resource control terminal apparatus transmits said access confirmation message.

10. The resource control terminal apparatus according to claim 3, wherein said resource control program code comprises the steps of:
transmitting said access limit search request when an access request is received from another program;
receiving a reply to said access limit search request; and
determining according to said reply whether or not said access request can be accessed.

11. The resource control terminal apparatus according to claim 4, wherein said resource control program code comprises the steps of:
specifying a program ID indicating the other program to said access limit search means when an access request is received from the other program;
transmitting said access limit search request; receiving a reply to said access limit search request; and
determining whether or not access at said access request can be accepted according to said reply.

12. The resource control terminal apparatus according to claim 5, wherein said resource control program code comprises the steps of:
specifying said profile for said access limit search means when receiving an access request from another program;
transmitting said access limit search request;
receiving a reply to said access limit search request; and
determining whether or not said access request can be accepted according to said reply.

13. The resource control terminal apparatus according to any one of claims 3 to 5, wherein said resource control program code comprises the steps of:
performing an access limit search request in a same procedure as an access confirmation request issued from a current program when receiving an access confirmation request from another program; and
determining whether or not the access confirmation request can be accepted according to a reply to the request.

14. A computer-processible medium storing a program and/or data used to direct a computer to perform all or a part of functions of all or a part of means of the resource control terminal apparatus or the GUI-equipped terminal apparatus according to any one of claims 1 to 9.

15. An information aggregate which is a program and/or data used to direct a computer to perform all or a part of functions of all or a part of means of the resource control terminal apparatus or the GUI-equipped terminal apparatus according to any one of claims 1 to 9.

16. A computer-processible medium storing the steps of all or a part of said resource control program code of said resource control terminal apparatus according to any one of claims 10 to 13.
